(19) United States
(12) Patent Application Publication
(10) Pub. No.: US 2015/0280526 A1
(43) Pub. Date: Oct. 1, 2015

(54) ELECTRIC MACHINE WITH HEAT TRANSFER ENHANCER

(71) Applicant: Remy Technologies, L.L.C., Pendleton, IN (US)

(72) Inventors: Bradley D. Chamberlin, Pendleton, IN (US); Dave Fulton, Anderson, IN (US); Jeffrey H. Burns, Carmel, IN (US)

(73) Assignee: Remy Technologies, L.L.C., Pendleton, IN (US)

(21) Appl. No.: 14/228,365

(22) Filed: Mar. 28, 2014

(51) Int. Cl. H02K 9/22; H02K 3/24

(52) U.S. Cl. CPC H02K 9/22; H02K 3/24

(57) ABSTRACT

An electric machine includes a core defining a first axial end, a second axial end opposite the first axial end, and a plurality of slots extending between the first axial end and the second axial end. Windings are wound on the core. The windings include in-slot portions positioned in the plurality of slots and end turn portions positioned on the first axial end and the second axial end. A cooling tube is coupled to the end turn portions of the windings. A heat transfer member extends between the cooling tube and the windings and is in contact with the cooling tube and the windings.

### FIELD

This document relates to the field of electric machines, and particularly to cooling arrangements for electric machines.

### BACKGROUND

Electric machines come in various forms and are used in various applications. Common exemplary electric machines include AC and DC motors, induction machines, permanent magnet machines, synchronous machines, asynchronous machines, as well as numerous other types and configurations of electric machines. Most electric machines include a rotor and a stator with windings positioned on at least one of the stator and rotor. One common use of the electric machine is that of an alternator in automotive and heavy duty vehicle applications. Another common use of the electric machine is that of a drive propulsion system in electric and hybrid vehicles. These applications often require relatively high output electric machines capable of producing a relatively large amount of torque.

In high power output machines with high torque, a great deal of heat is generated in the windings of the electric machine. Extracting heat from electric machines is desirable in order to increase the longevity, reliability and performance of the electric machine. This is particularly true of the stator assemblies in concentrated wound electric machines, as excessive heat tends to break-down the insulation system associated with the electric machine windings while also decreasing the output and efficiency of the electric machine.

A stator arrangement from a typical concentrated wound electric machine is shown FIGS. 1-3. As shown in FIG. 1, the electric machine includes a stator 12 including a stator core 14 and three-phase windings 16 positioned on the stator core 14. The three-phase windings 16 are wound in slots 38 formed in the stator core. In some electric machines, a winding isolator 18 (which may also be referred to herein as a “bobbin”) is inserted onto the slots 38 at the ends of the stator core 14, as shown in FIG. 2. The bobbin 18 separates the windings 16 from the stator core 14, providing both electrical and thermal insulation between the windings 16 and the stator core 14. The bobbin 18 may include two sections 18a and 18b that are inserted onto the ends of the stator core, as indicated by arrows 20. In other electric machines, a bobbin 18 is not used as an insulator, and other insulation means are used to insulate the windings 16 from the core 14, such as flame-resistant meta-aramid paper and enamel.

As shown in FIG. 3, the stator 12 is positioned across an air gap 24 from a rotor 22 of the electric machine 10. As noted above, heat is generated in the stator windings 16 and core 14 during operation of the electric machine 10. Various methods and arrangements for cooling the electric machine are known. According to one method, the stator 12 is encased in a housing and cooling oil is pumped through the housing. According to another method, a cooling jacket that defines a channel is provided around the stator core and cooling fluid, such as water ethylene-glycol (WEG), is pumped through the channel to draw heat away from the stator. The cooling jacket arrangement may also be used in association with air that is blown over the stator core 14 and windings 16 in an attempt to cool the stator 12, as will be recognized by those of ordinary skill in the art.

Although various methods are known for cooling electric machines, extraction of heat from concentrated wound electric machines tends to be particularly difficult. One reason for this is that concentrated wound electric machines typically have relatively low end turn heights with a small surface area to dissipate heat. Additionally, the windings in these electric machines typically have tightly bundled end turns and in-slot portions, resulting in even less surface area exposure of the winding conductors. Also, a winding isolator/thermal insulator (also referred to herein as a “bobbin”) may be positioned between the conductor winding and the stator lamination stack (which may also be referred to herein as a “stator core”). Air pockets between the bobbin and the stator core as well as air pockets between the windings and the bobbin provide additional thermal resistance, making the electric machine more difficult to cool.

In view of the foregoing, it would be advantageous to provide an improved method and arrangement providing for heat transfer away from the winding conductors of electric machines, including electric machines with concentrated windings. It would also be advantageous for such improved method and arrangement for heat transfer to be relatively easy and inexpensive to manufacture in association with the electric machine.

### SUMMARY

In accordance with one exemplary embodiment of the disclosure, an electric machine includes a core defining a first axial end, a second axial end opposite the first axial end, and a plurality of slots extending between the first axial end and the second axial end. Windings are wound on the core, the windings including in-slot portions positioned in the plurality of slots and end turn portions positioned on the first axial end and the second axial end. A cooling tube is coupled to the end turn portions of the windings. A heat transfer member extends between the cooling tube and the windings and is in contact with the cooling tube and the windings.

Pursuant to another exemplary embodiment of the disclosure, there is provided a core with windings positioned on the core. A cooling tube is coupled to the windings and a heat transfer plate extends from the windings to the cooling tube. In at least one embodiment, the heat transfer plate includes a first portion that extends at least partially around the cooling tube and a second portion that is contacts a plurality of conductors and is sandwiched between the plurality of conductors.

In accordance with yet another exemplary embodiment of the disclosure, there is provided a method of operating an electric machine. The method includes energizing the windings wound on the core and directing fluid through a cooling tube in contact with the windings. The method further includes transferring heat generated in the windings to the cooling tube through a heat transfer plate extending from the windings to the cooling tube.

The above described features and advantages, as well as others, will become more readily apparent to those of ordinary skill in the art by reference to the following detailed description and accompanying drawings. While it would be desirable to provide a cooling arrangement for an electric machine that provides one or more of these or other advantageous features, the teachings disclosed herein extend to those embodiments which fall within the scope of the appended claims, regardless of whether they accomplish one or more of the above-mentioned advantages.

### BRIEF DESCRIPTION OF THE DRAWINGS

FIG. 1 shows a perspective view of a stator of an exemplary prior art concentrated wound electric machine;

FIG. 2 shows an exploded perspective view of a stator and bobbin arrangement for an exemplary prior art electric machine;

FIG. 3 shows a cross-sectional view of a stator and rotor of an exemplary prior art electric machine;

FIG. 4 shows a cross-sectional view of an electric machine including a stator core and stator windings with cooling tubes coupled to the stator windings;

FIG. 5 shows a side view of one of the cooling tubes of FIG. 4, including embodiments of surface features formed on the cooling tube;

FIG. 6 shows a cross-sectional view of an embodiment of the electric machine of FIG. 4 including a cooling jacket connected to the cooling tubes;

FIG. 7 shows a top view of an embodiment the cooling tubes of FIG. 4 in relation to end turns of the windings, the windings represented linearly and in cross-section;

FIG. 8 shows a top view of an alternative arrangement for the cooling tubes of FIG. 7, the cooling tubes extending around the end turns;

FIG. 9 shows a top view of another alternative arrangement for the cooling tubes of FIG. 7, the cooling tubes extending through the end turns and exiting the end turns alternately on inner diameter and outer diameter sides of the end turns;

FIG. 10 shows a top view of yet another alternative arrangement for the cooling tubes of FIG. 7, the cooling tubes extending between and through the end turns in a circumferential direction;

FIG. 11 shows a perspective view of a heat transfer plate configured to couple the cooling tube of FIG. 4 to the windings;

FIG. 12 shows a cross-sectional view in the circumferential direction of an arrangement including a bobbin and end turns with the heat transfer plate of FIG. 11 coupling the cooling tube to the end turns;

FIG. 13 shows an alternative embodiment of the arrangement of FIG. 12 with a heat transfer plate having two extensions engaging the windings;

FIG. 14 shows another embodiment of the arrangement of FIG. 12 with two heat transfer plates coupling cooling tubes to the end turns;

FIG. 15 shows yet another alternative embodiment of the arrangement of FIG. 12 with the heat transfer plate extending between the spool and the windings;

FIG. 16 shows another alternative embodiment of the arrangement of FIG. 12 with the heat transfer plate extending across an axially outermost layer of the windings;

FIG. 17 shows a perspective view of the heat transfer plate used in the arrangement of FIG. 16;

FIG. 18 shows a cross-sectional view of an embodiment of the bobbin and heat transfer plate of FIG. 15 with the bobbin molded over the heat transfer plate to form a unitary component;

FIG. 19 shows a cross-sectional view of another embodiment of the bobbin of FIG. 15 with the bobbin co-molded with the heat transfer plate to form a unitary component; and

FIG. 20 shows a block diagram of a method of making a stator core including a bobbin and heat transfer enhancer.

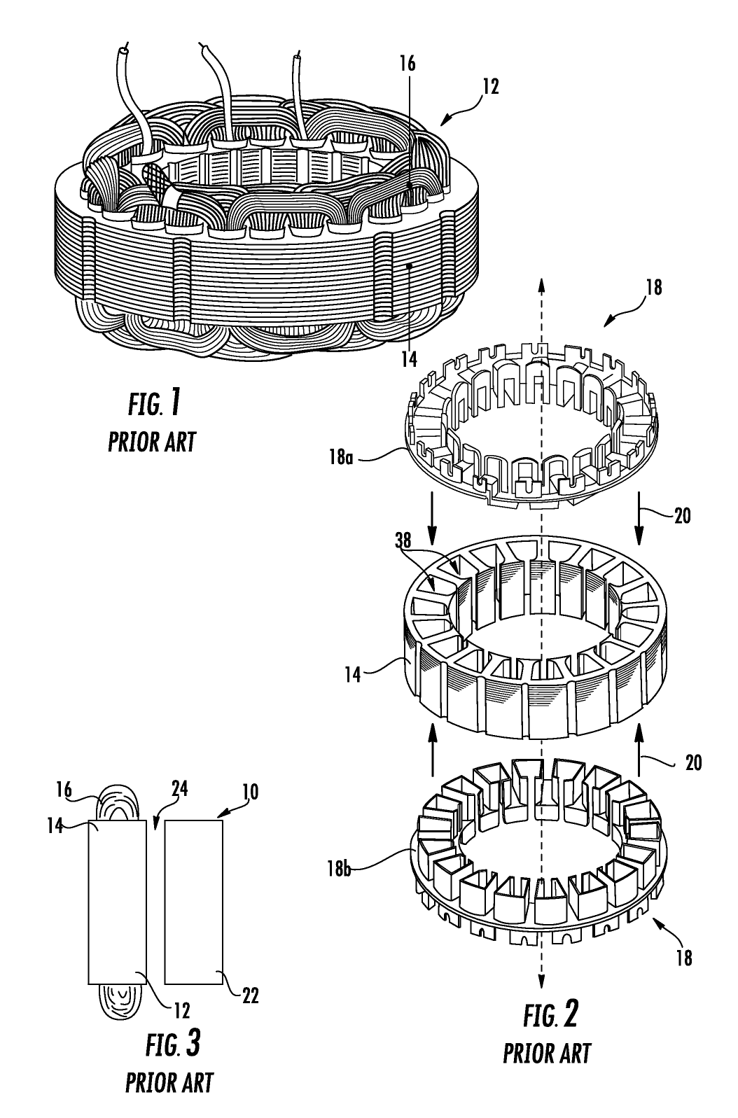

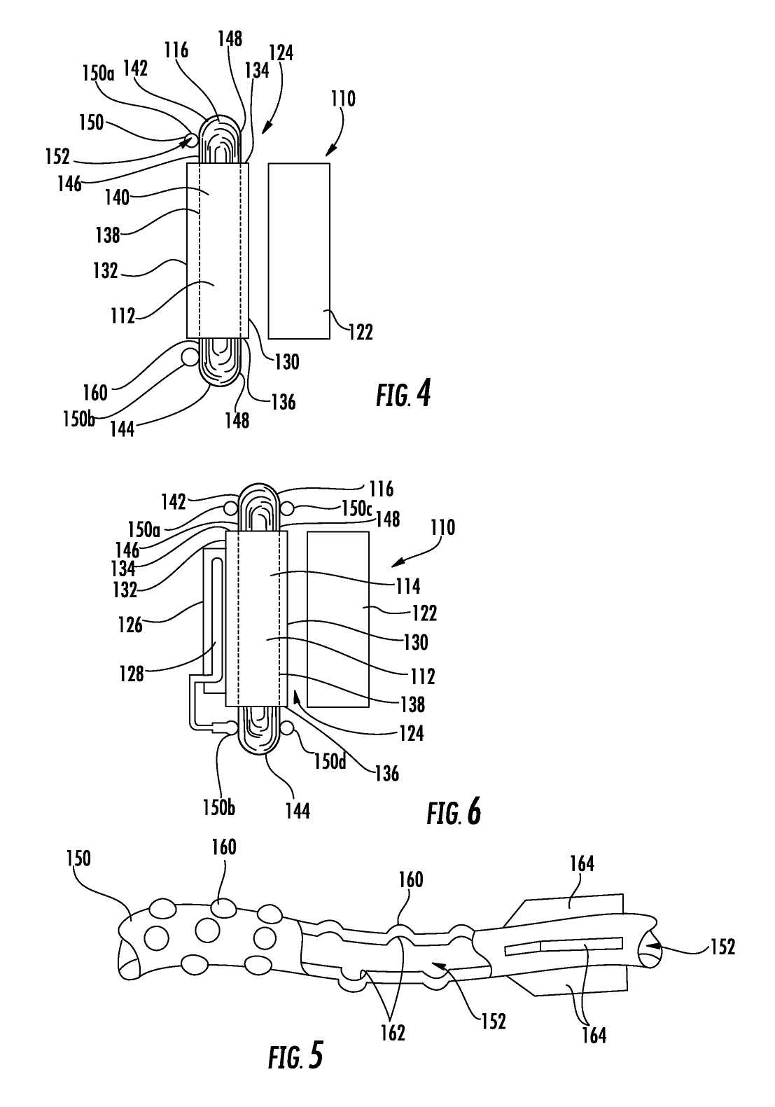

### DESCRIPTION

With reference to FIG. 4, in at least one embodiment an electric machine 110 includes a stator 112 and a rotor 122 with cooling tubes 150 configured to provide for heat transfer from the electric machine. As explained in further detail below, the cooling tubes 150 are coupled to the stator and are configured to direct cooling fluid around the stator 112.

The stator 112 includes a core member in the form of a stator core 114 comprised of iron sheets that are placed upon one another to form a lamination stack. The stator core 114 is generally cylindrical in shape and defines an inner diameter 130, and outer diameter 132, a first end 134 and an opposing second end 136. Slots 138 extend in an axial direction between the first end 134 and the second end 136 of the stator core 114 (one of the slots is represented by dotted lines in FIG. 4 since the slot is behind the plane shown in the figure).

Three-phase windings 116 are positioned on the stator core 114. The three-phase windings 116 are comprised of lengths of wire (e.g., copper wire) wound through the stator slots 138 to form coils, as will be recognized by those of ordinary skill in the art. Thus, the windings 116 include in-slot portions 140 and end turn portions 142, 144. The in-slot portions 140 include the lengths of conductors located within the stator slots 138, and the end turn portions 142, 144 include the lengths of conductors located outside of the stator slots 138 and bridging between two different slots in the stator core 114. The end turn portions 142,144 are generally curved, and may be referred to as “U-turn portions”. The wires that form the windings may be coated with an enamel material to provide electrical insulation between the wire and the stator core 114. In at least one embodiment, a bobbin (not shown in FIG. 4) is positioned on one or more ends 134, 136 of the stator core 114. The bobbin extends into the slots 138 to provide additional electrical insulation between the wire and the stator core 114. Additionally, while the windings 116 have been described herein as being formed from a length of wire wound through the slots 138 of the stator core 114, it will be recognized that in other embodiments the windings 116 may be formed differently, such as windings formed by interconnection of conductor segments, as will be recognized by those of ordinary skill in the art.

As shown in FIG. 4, the stator 112 is positioned across an air gap 124 from a rotor 122 of the electric machine 10. The rotor may be provided in any of various configurations, depending upon the type of electric motor. For example, the rotor may include a number of permanent magnets if the electric machine is a permanent magnet machine, or may include laminations of slotted ferromagnetic material with windings formed in the slots if the electric machine if the electric machine is a three-phase induction motor. It will be recognized by those of ordinary skill in the art that other types of rotors are also possible for other types of electric machines.

Cooling Tubes Coupled to Stator Windings

With continued reference to FIG. 4, one or more cooling tubes 150 are coupled to the electric machine 110 such that the tubes 150 are in direct contact or near direct contact with the windings 116. The tubes 150 are configured to retain a cooling fluid and allow the cooling fluid to flow through a passageway 152 defined by the tube 150. In the embodiment of FIG. 4, each tube 150 is provided as a hollow elongated cylinder that extends in a circumferential direction around the outer diameter side 146 of the windings 116. In various embodiments disclosed herein, the tubes 150 are shown as having a circular cross-section, but it will be appreciated that in other embodiments the tubes 150 may have different cross-sectional shapes, such as square, rectangular or triangular shapes. The cross-sectional diameter of the tube is generally a function of the size of the stator core. For stator cores with a larger outer diameter, the diameter of the cooling tube will be larger. For stator cores with a smaller outer diameter, the diameter of the cooling tube will be smaller. Exemplary sizes of cooling tubes include larger tubes having a diameter of about 50 mm and smaller tubes having a diameter of about 2 mm, or any diameter in between. In yet other embodiments, the cooling tubes may have diameters outside of these ranges. Furthermore, in the embodiment of FIG. 4, both a first tube 150a and a second tube 150b are provided in contact with the windings 116. The first tube 150a is in contact with the first end turns 142 on the first end 134 of the stator core 112, an and a second tube 150b in contact with the second end turns 144 on the second end 136 of the stator core 112.

The tubes 150 may be comprised of any of various thermally conductive materials. For example, in at least one embodiment, the tubes 150 are comprised of an aluminum material. In this embodiment, a thermally conductive but electrically insulating material, such as an epoxy, is positioned between the windings 116 and the tubes 150. Advantages of the tubes being comprised of a metal material include good thermal conductivity and solid structure. In at least one alternative embodiment, the tubes 150 are comprised of a polymer material that is itself electrically insulating but thermally conductive, such as an ultra-high molecular weight polyethylene, or a thermally conductive polypropylene. Such a polymer material may be coated with a polyimide film to provide additional dielectric qualities while maintaining relatively high thermal conductivity. Advantages of the tubes being comprised of a polymer material include a compliant and more easily formable structure along with corrosion resistance.

In addition to the tubes 150 being comprised of thermally conductive material, the tubes 150 may also include additional features that facilitate heat transfer. In particular, the tubes may include a plurality of surface features that increase the surface area of the tube to further encourage dissipation of heat from the tube as air flows over the tube. Examples of such additional surface features include dimples, bubbles or even heat fins. FIG. 5 shows various surface features provided on a tube 150. A first portion of the tube 150 includes bubbles 160 on an exterior of the tube to increase the surface area for heat to flow out of the tube as air passes over the increased surface area. A second portion of the tube 150 includes dimples 162 on an interior and an exterior surface of the tube. The dimples 162 not only increase the surface area of the tube 150, but also introduce turbulence into the tube 150 to further facilitate heat transfer from the fluid flowing in the passageway 152 to the exterior of the tube. A third portion of the tube includes heat fins 164 positioned on the tube to increase the surface area of the tube and allow heat to flow out of the tube as air passes over the fins.

With reference again to FIG. 4, the tubes 150a and 150b may be coupled to the end turns 142 and 144 in any of various ways. For example, a thermally conductive adhesive material may be used to directly connect the tubes 150a and 150b to the winding end turns 142, 144. In yet another embodiment, a mechanical coupling, such as a plastic cable tie or twist tie may be used to directly connect the tubes 150a and 150b to the windings end turns 142, 144. Additional options are also available for attaching the tubes 150a and 150b to the end turns 142, 144, either directly or indirectly, including the use of a bobbin and a heat transfer plate member, as discussed below with reference to FIGS. 11-17.

Any of various cooling fluids may be used within the tubes 150a and 150b. For example, the cooling fluid may be WEG, water, oil, or any of various other fluids configured to transfer heat away from the electric machine through the tube. The tubes 150a and 150b are connected to a pump configured to move the cooling fluid within the tubes 150a and 150b. The pump may be located in proximity of the electric machine 110, or remote from the electric machine 110 and connected to the tubes 150a and 150b through one or more elongated fluid lines. Furthermore, in at least one embodiment active refrigeration cycle may be used in association with the cooling fluid to provide further cooling capabilities for the electric machine.

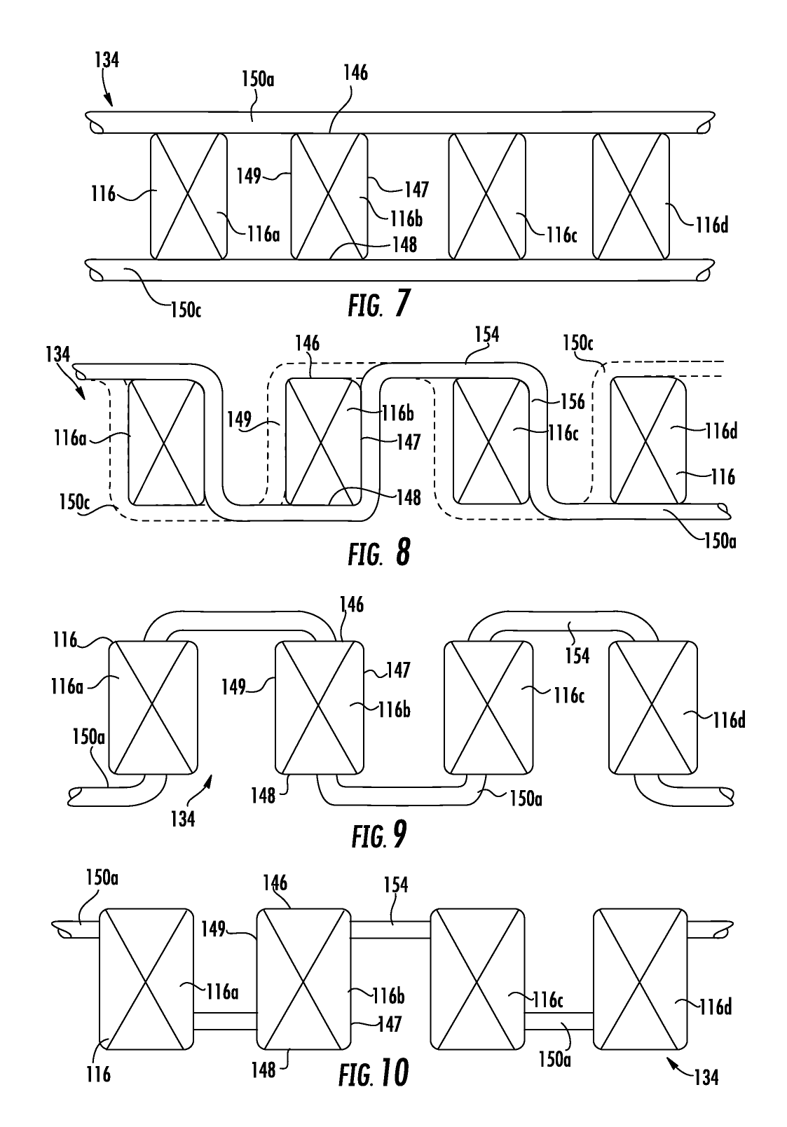

In at least one embodiment, as shown in FIG. 6, a cooling jacket 126 is attached to the stator 112 of the electric machine 110. The cooling jacket 126 extends substantially around the stator core 114 and includes a channel 128 that is configured to pass cooling fluid, such as WEG, and transfer heat away from the stator 112. The cooling jacket 126 may be comprised of a thermally conductive polymer material and is attached directly to the outer circumference of the stator core 14. A fluid line 127 extends from the cooling jacket 126 and provides a fluid passage between the channel 128 of the cooling jacket 126 and the tubes 150a and 150b. Accordingly, cooling fluid flowing through the channel 128 of the cooling jacket 126 is also directed through the tubes 150a and 150b. Also, in the embodiment of FIG. 6, two additional tubes 150c and 150d are provided on the inner diameter side 148 of the windings 116. Together, the cooling jacket 126 and the tubes 150a-150d provide a cooling arrangement for the electric machine 110.

During operation of the electric machine 110, heat is generated in the stator windings 116 and stator core 114. Heat from the stator windings 116 and the stator core 114 is transferred by thermal conduction to the tubes 150a and 150b attached to the windings 116 of the electric machine 110. In the embodiment of FIG. 6, heat is also transferred from the electric machine 110 by the cooling jacket 126 that extends around the stator core 114 and the additional tubes 150c and 150d on the inner diameter side 148 of the windings 116. Advantageously, because the channel 128 of the cooling jacket 126 is in fluid communication with tube 150b, and tube 150b is in fluid communication with tubes 150a, 150c and 150d, a single pump may be used to force fluid to flow through the cooling jacket 126 and the tubes 150a-150d. Cooling fluid may flow through the system in various ways depending on the connections between the cooling jacket 126 and the tubes 150a and 150b. For example, cooling fluid may flow in a serial manner from the cooling jacket to the first tube 150a and then to the second tube 150b. As another example, multiple connections between the cooling jacket 126 and the tubes 150a and 150b may allow for parallel fluid flow through the cooling jacket 126 and the tubes 150a and 150b.

With reference now to FIGS. 7-10, several different exemplary arrangements are shown for contacting the tubes 150 with the windings 116. In each of FIGS. 7-10 the end turns 142 of the windings 116 are illustrated for convenience in a linear manner from a top (axial) view, showing the first end 134 of the stator 112 with four conductor groups 116a-116d from the windings represented, each conductor group is a group of conductors that extends through a slot within the stator core 114. Each conductor group 116a-116d combines with other conductor groups to form one or more end turns at the first end of the stator 112. It will be recognized by those of ordinary skill in the art that the complete windings 116 will typically include more conductor groups than the four conductor groups 116a-116d illustrated in FIGS. 7-10, and that the complete windings extend in a circumferential manner around the entire stator core.

With particular reference now to FIG. 7, in at least one embodiment, a first tube 150a extends circumferentially around the stator 112 on an outer diameter side 146 of the winding 116, and a second tube 150c extends circumferentially around the stator 112 on an inner diameter side 148 of the winding 116. These tubes 150a and 150c are in contact with and are secured to the conductor groups 116a-116d, on the inner diameter side 146 and the outer diameter side 148 of the winding 116, respectively. While the tubes 150a and 150c contact the inner diameter side 146 and outer diameter side 148 of the winding 116, they do not extend into or between groups of the winding conductors (e.g., conductor groups 116a-116d shown in FIG. 7). Accordingly, the path of each tube 150a and 150b is a generally direct circumferential path that does not curve or wind such that the path includes a radial component in travelling around the stator 112. While only one or two tubes 150 are shown in each of the embodiments of FIGS. 6-9, it will be recognized that additional tubes could be utilized, including additional tubes on either the end 134, 136 of the stator 112, or on the inner or outer diameter side of the end turns 142, 144. For example, two or three tubes could be stacked axially above or below tube 150a and take the same course around the outer diameter of the stator as tube 150a on the first end 134 of the stator 112, as shown in FIG. 7. Furthermore, additional tubes taking the same or similar paths may be provided on the inner or outer sides of the end turns 142, 144 or on the first end 134 or second end 136 of the stator 112.

With reference now to FIG. 8, in at least one alternative embodiment, the first tube 150a and the second tube 150b extend circumferentially around the stator 112 along paths that are generally winding with a plurality of curves such that the tubes 150a and 150c contact both the outer diameter side 146 and the inner diameter side 148 of the end turns 142. In particular, the path of each tube 150a and 150c snakes between the conductor groups 116a-116d (a winding path with a plurality of curves may be referred to herein as a “snaking” path). The first tube 150a includes a circumferential portion 154 that alternates between contact with the outer diameter side 146 of odd conductor groups (e.g., 116a, 116c, etc.) and the inner diameter side 148 of even conductor groups (e.g., 116b, 116d, etc.). In snaking between the outer diameter side 146 and the inner diameter side 148 of the conductor groups, the tube 150a also includes a radial portion 156 that contacts the right side of the conductor group, whether even or odd. Similarly, the second tube 150c includes a circumferential portion that alternates between contact with the inner diameter side 148 of odd conductor groups (e.g., 116a, 116c, etc.) and the outer diameter side 146 of even conductor groups (e.g., 116b, 116d, etc.). When snaking between the outer diameter side 146 and the inner diameter side 148 of the conductor groups/end turns, the tube 150c also includes a radial portion that contacts the left side of the conductor group, whether even or odd. Therefore, in the embodiment of FIG. 8, tubes 150a and 150c advantageously surround each conductor group and provide heat transfer away from multiple sides of the end turns.

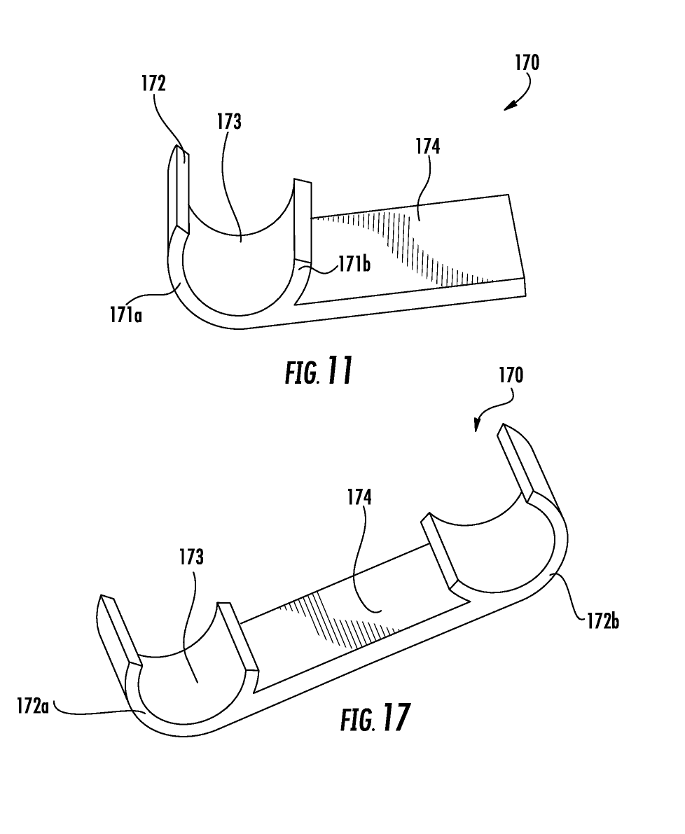

With reference now to FIG. 9, in at least one alternative embodiment, a single tube 150a is used to contact the end turns 142 on the first end 134 of the stator. In this embodiment, the tube 150a extends circumferentially around the stator 112 along a winding path that includes both a circumferential portion 154 and a radial portion 156. The radial portion 156 extends radially through each conductor group 116a-116d, moving between the outer diameter side 146 and the inner diameter side 148 of each conductor group. In this embodiment, the path of the tube 150a includes a circumferential portion 154 extending between adjacent conductor groups 116a-116d alternating between the outer diameter side 146 and the inner diameter side 148 of the end turns 142. Advantageously, with the arrangement of FIG. 9, cooling is provided directly to the interior of each winding group where heat transfer is otherwise difficult to facilitate. Because the tube 150 goes between conductors that form a conductor group, the tube 150 with this arrangement should be positioned in relation to the stator core 114 prior to winding the conductors on the stator core 114 to form the windings 116. In other words, the windings 116 should be formed around the tube 150a during manufacture of the stator 112 (e.g., the conductor may be lapped over the tube during the winding manufacturing process).

With reference now to FIG. 10, in at least one alternative embodiment, a single tube 150a is used to contact the end turns 142 on the first end 134 of the stator. Similar to the arrangement of FIG. 9, in the arrangement of FIG. 10 the tube 150a extends circumferentially around the stator 112 along a winding path that extends radially through each conductor group 116a-116d, moving between the outer diameter side 146 and the inner diameter side 148 of each conductor group. However, in the arrangement of FIG. 10, the circumferential portion 154 of the path extends between adjacent conductor groups 116a-116d at positions between the outer diameter side 146 and the inner diameter side 148 of the conductor groups 116a-116d. Thus, the circumferential portions of the path are never positioned completely on the outer diameter side 146 or the inner diameter side 148 of the conductor groups 116a-116d. Advantageously, with the arrangement of FIG. 10, cooling is provided directly to the interior of each winding group where heat transfer is otherwise difficult to facilitate. Also, with the arrangement of FIG. 10, the windings 116 are formed around the tube 150a during manufacture of the stator 112, as it may be difficult or impossible to insert the tube between the windings 116 after formation of the windings in the slots of the stator core 114.

Heat Transfer Member Engaging the Tube and Windings

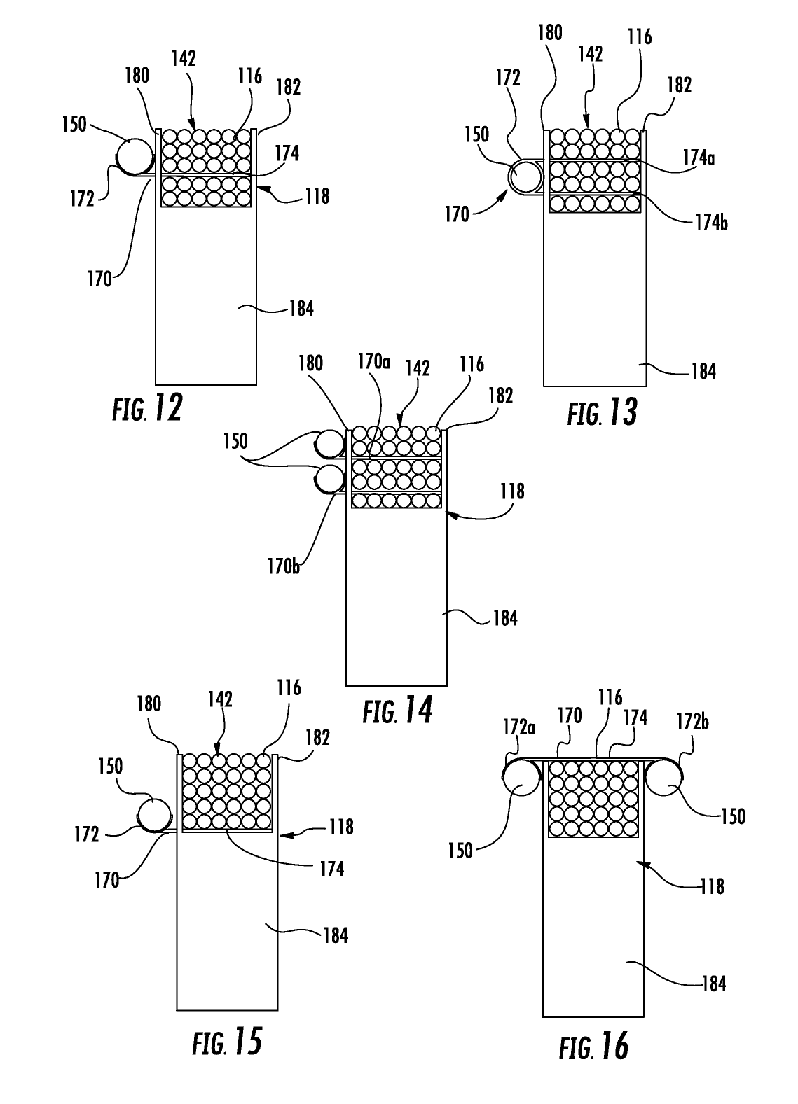

With reference now to FIGS. 11-12, in at least one embodiment, a heat transfer enhancer (which may also be referred to as a heat transfer member) is shown in the form of a heat transfer plate 170. The heat transfer plate 170 is designed and dimensioned to both transfer heat from the windings 116 to the tube 150 and couple the tube 150 to the windings 116. The heat transfer plate 170 includes a tube portion 172 at one end and a winding portion 174 at an opposite end.

In the embodiment of FIG. 11, the tube portion 172 of the heat transfer plate 170 is semi-cylindrical in shape, with two opposing curved arms 171a, 171b that together provide a cupped surface 173 configured to cradle a length of the tube 150 by extending at least partially around the tube 150. Accordingly, the semi-cylindrical part of the tube portion 172 has a diameter that is slightly larger than that of the tube 150, allowing the tube 150 to fit within the semi-cylindrical part of the tube portion 172. In at least one embodiment, the cupped surface 173 is designed and dimensioned to extend at least 180° around the tube 150. While the cupped surface 173 is shown in the embodiments herein as being substantially smooth and semi-cylindrical in shape, it will be recognized that in other embodiments the cupped surface 173 may be formed by two or more substantially flat surfaces that meet at an angle to form a cupped surface.

The tube 150 may be secured to the tube portion 172 by any of various means including the use of adhesives, brazing, potting, friction fit, crimping, or mechanical fasteners, such as cable ties. If crimping is used to secure the tube 150 to the tube portion 172, the arms of the tube portion 172 extend substantially around the tube 150 and are flexible but non-resilient. When the ends of the arms are forced toward one another, the arms trap the tube 150 in place. In embodiments where brazing or adhesives are used to secure the tube 150 to the tube portion 172, the arms 171a, 171b of the tube portion may be shorter, curving only a small distance around the tube 150, or even non-existent with the tube portion 172 substantially flat and the tube 150 brazed, adhered, or otherwise connected to the heat transfer plate 170 at the tube portion 172.

The winding portion 174 of the heat transfer plate is provided as a thin flat plate having a substantially rectangular shape. However, it will be recognized that the winding portion 174 may be shaped differently in other embodiments. The winding portion 174 extends away from the tube portion 172, allowing the winding portion 174 to engage the conductors of the winding 116 (as shown in FIG. 12). The winding portion 174 is sufficient in width (i.e., in the direction extending away from the tube portion 172) such that the winding portion 174 extends across most or all of the conductors in a layer of conductors of a conductor group (e.g., across one layer of one of conductor groups 116a-116d).

The heat transfer plate 170 is generally a one-piece component that may be integrally formed through a molding or stamping process. The heat transfer plate 170 may be configured from any of various thermally conductive materials, including metallic materials or thermally conductive dielectric plastics. For example, in at least one embodiment, the heat transfer plate 170 is comprised of aluminum. In at least one alternative embodiment, the heat transfer plate 170 is comprised of a thermally conductive polypropylene or polyamide material, such as that those polymers sold by Cool Polymers, Inc. under the trademark COOL POLYMERS®.

As noted above, the tube portion 172 of the heat transfer plate 170 is configured to engage and retain the tube 150 next to the windings 116, while the winding portion 174 is configured to extend into (or across) the windings 116 and engage the windings 116. Because the heat transfer plate 170 is comprised of a highly thermally conductive material that engages the windings 116 at one end and the cooling tube 150 at the other end, the heat transfer plate 170 provides a more direct method of heat transfer from the windings to the cooling tube 150. Heat generated in the windings is transferred to the winding portion 174 and then outward to the tube portion 172. The cooling fluid flowing through the tube 150 then carries the heat away from the tube portion 172, cooling the electric machine 110. The heat transfer plate 170 may be used in association with or without a bobbin 118, as explained in further detail below.

With reference now to FIG. 12, the heat transfer plate 170 is shown extending though a bobbin 118 retaining the windings 116 on the stator core (not shown in FIG. 12). The bobbin 118 includes an outer diameter wall 180 and an inner diameter wall 182 with the end turns 142 of the windings 116 retained between the outer diameter wall and the inner diameter wall 182. The bobbin 118 also includes slot extensions 184 that extend into the slots of the stator core 114. The tube portion 172 of the heat transfer plate 170 extends radially outward from the outer diameter wall 180. The winding portion 174 of the heat transfer plate extends radially inward from the outer diameter wall 180.

As shown in FIG. 12, the tube portion 172 of the heat transfer plate 170 wraps partially around the tube 150, securely retaining the tube 150 in direct contact with the bobbin 118 and in near direct contact with the windings 116. Accordingly, the tube 150 is only a short distance away from the windings 116, separated from the windings 116 only by the thickness of the wall 180 positioned on the outer diameter of the bobbin 118. The tube 150 may be retained in place on the tube portion 172 by any of various means such as a snap-fit or clip arrangement where the tube 150 is trapped between the bobbin 118 and the tube portion 172. Other exemplary fastening means include a brazed connection (e.g., brazing the tube 150 and the heat transfer plate 170 or bobbin 118 together), a crimped connection (e.g., crimping the ends of the tube portion 172 toward one another to trap the tube 150 in place on the heat transfer plate 170), an adhered connection (e.g., adhesive between the tube portion 172 and the tube 150), a potted connection (e.g., potting the tube 150 in an epoxy or other potting material within the tube portion 172 of the heat transfer plate), or mechanical fasteners (e.g., cable ties to retain the tube 150 in place relative to the bobbin 118), as well as various other connection means. While the tube is shown in direct contact with the bobbin 118 in FIG. 12, it will be recognized that in at least one alternative embodiment, the tube portion 172 of the heat transfer plate may extend between the tube 150 and the bobbin 118.

The winding portion 174 of the heat transfer plate 170 extends through a passage in the outer diameter wall 180 of the bobbin 118 and into the collection of conductors that form the windings 116. In the embodiment of FIG. 12, the winding portion 174 of the heat transfer plate 170 extends between and is sandwiched by the conductors in a second layer and a third layer of the end turns 142. Accordingly, in this embodiment, the heat transfer plate 170 is in contact with conductors on two opposing sides of the winding portion 174. During operation of the electric machine, the heat transfer plate 170 conducts heat from the windings 116 to the cooling tube 150, resulting in significant cooling of the conductors in the end turns 142 shown in the embodiment of FIG. 12. Furthermore, while the heat transfer plate 170 of FIGS. 11 and 12 has been shown as extending only a relatively short distance in the circumferential direction, it will be recognized that in other embodiments the heat transfer plate may include additional curvature and extend further in the circumferential direction. The length of the heat transfer plate 170 in the circumferential direction may depend in part on the design of the electric machine and the length of the end turns 142 in the circumferential direction. Moreover, it will be recognized that different shapes and quantities of heat transfer plates are possible, including those exemplary embodiments described below with reference to FIGS. 13-17.

In the embodiment of FIG. 13, the tube portion 172 of the heat transfer plate 170 forms a complete or substantially complete cylinder. The complete or substantially complete cylinder includes a passage in the circumferential direction of the electric machine, allowing the tube 150 to be inserted through the cylinder without damage to the tube 150. If the tube portion 172 provides a substantially complete cylinder, the substantially complete cylinder covers the outer side of the tube 150 (i.e., the side of the tube farthest from the bobbin 118 in the radial direction), encircling at least 180° of the tube 150. However, the substantially complete cylinder is open on the inner side of the tube 150 (i.e., the side of the tube closest to the bobbin 118 in the radial direction), allowing the inner side of the tube 150 to contact the bobbin. The winding portion of the heat transfer plate 170 of FIG. 13 includes an upper winding portion 174a and a lower winding portion 174b. The upper winding portion 174a is connected to a first axial side (i.e., and upper side) of the tube portion 172 and extends away from the tube portion in a radial direction. Similarly, the lower winding portion 174b is connected to a second axial side (i.e., a lower side) of the tube portion 172 and extends away from the tube portion in a radial direction. The upper and lower winding portions 174a and 174b extend through passages in the outer diameter wall 180 of the bobbin 118 and into the collection of conductors that form the windings 116. In the embodiment of FIG. 13, the upper winding portion 174a is sandwiched between conductors in the third and fourth layers of the end turns 142, and the lower winding portion 174b is sandwiched between conductors in the first and second layers of the end turns 142. Accordingly, in this embodiment, the heat transfer plate 170 extends between and is in contact with conductors on four different layers of the winding portion 174. During operation of the electric machine, the heat transfer plate 170 conducts heat from the windings 116 to the cooling tube 150, resulting in significant cooling of the conductors in the end turns 142.

With reference now to FIG. 14, in at least one embodiment, two or more heat transfer plates 170 may be used in association with a single end turn 142. The heat transfer plates in FIG. 14 include an upper heat transfer plate 170a and a lower heat transfer plate 170b. The heat transfer plates 170a and 170b are shaped identical to the heat transfer plate of FIGS. 11 and 12. Heat transfer plate 170a includes a winding portion that is sandwiched between conductors in layers 3 and 4 or the end turns 142 and heat transfer plate 170b includes a winding portion that is sandwiched between conductors in layers 1 and 2 of the end turns 142.

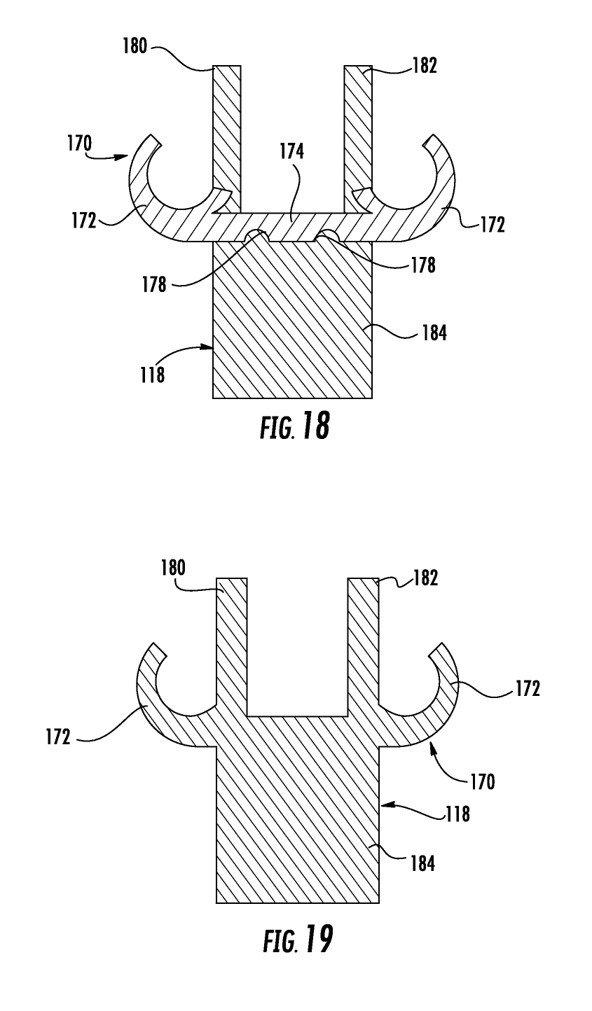

FIG. 15 shows yet another embodiment of the heat transfer plate 170. The heat transfer plate in FIG. 15 is shaped identical to the heat transfer plate of FIGS. 11 and 12. However, the winding portion 174 of the heat transfer plate 170 of FIG. 15 is in contact with only a single layer of conductors on the end turns, and particularly, an axially innermost layer of the conductors. The opposite side of the winding portion 174 is in contact with the bobbin 118. As a result, the heat transfer plate 170 in FIG. 15 is sandwiched between the bobbin 118 and the first layer of conductors of the end turns 142.

FIGS. 16 and 17 show another embodiment of the heat transfer plate 170. The heat transfer plate 170 is similar to that shown in FIG. 11, but in the embodiment of FIGS. 16 and 17, the heat transfer plate 170 includes two tube portions 172a and 172b positioned at opposite ends of the winding portion 174. Each tube portion 172a and 172b includes a cupped surface that is configured to engage a cooling tube 150. As shown in FIG. 16, when the heat transfer plate 170 engages the windings 16, tube portion 172a is positioned adjacent to the outer diameter wall 180 of the bobbin 118, and tube portion 172b is positioned adjacent to the inner diameter wall 182 of the bobbin 118. The winding portion 174 of the heat transfer plate 170 is in contact with only those conductors on the outermost layer of the end turns. The winding portion 174 does not extend through the bobbin 118, but does contact the outer axial edge of the bobbin 118. Advantageously this arrangement allows a cooling tube 150 to be positioned on both the outer diameter side of the windings 116 and the inner diameter side of the windings 116. Because the tube portion 172b and the associated tube 150 are positioned sufficiently outward from the stator core in the axial direction, the arrangement does not interference with the rotor during operation of the electric motor.

Heat Transfer Member and Bobbin as a Unitary Component

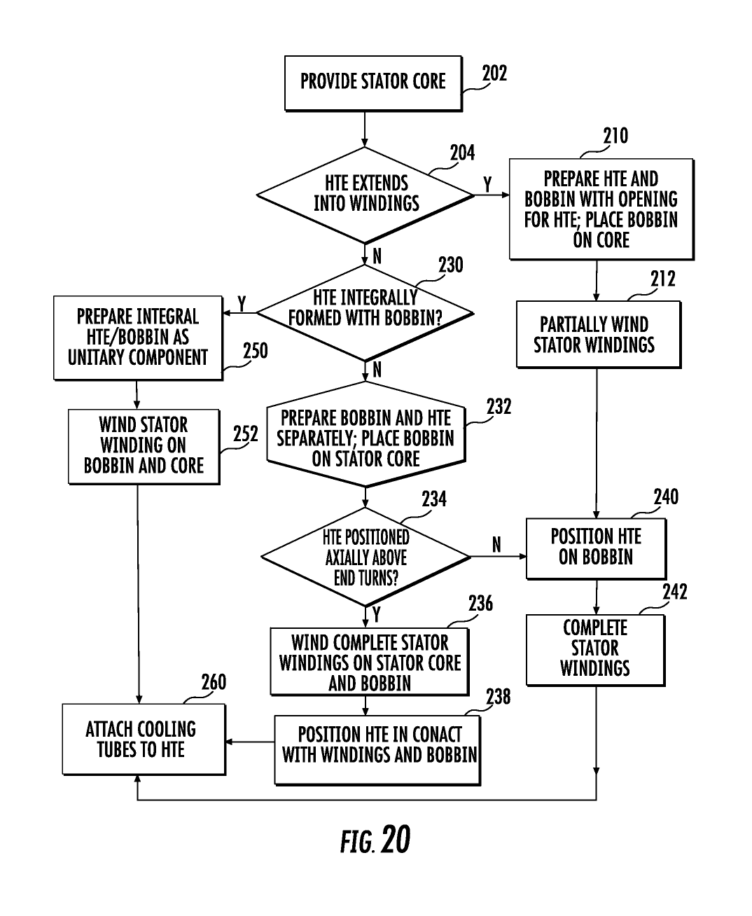

With reference now to FIGS. 18-19, in at least one alternative embodiment, the bobbin 118 is integrally formed with the heat transfer plate 170 to provide a unitary component. The term “unitary component” as used herein refers to a component where the constituent parts of a component non-removeably joined together without destruction of the component. For example, parts that are integrally formed together by injection molding or other molding processes, including two parts co-molded together at the same time, or a first part over-molded on a second part, may be considered to form a “unitary component”. As another example, two parts that are welded together such that the parts incapable of separation without damaging one or more of the parts may be considered to be a unitary component. Two parts that are “integral with” each other, or two parts that are “integrally formed”, provide unitary component.

With particular reference to FIG. 18, a cross-sectional view of a bobbin 118 is shown including an outer diameter wall 180, and inner diameter wall 182, a slot extension 184. The bobbin 118 is formed as a unitary component with a heat transfer plate 170. In this embodiment, the bobbin 118 is formed of a first material that is thermally conductive but electrically insulating, such as a highly thermally conductive polyamide or polypropylene. The heat transfer plate 170 is formed of a second material that is also thermally conductive, such as aluminum. When the heat transfer member 170 is comprised of a different material than the bobbin 118, the heat transfer ember 170 may have a higher thermal conductivity than the bobbin 118. Accordingly, heat generated by the windings 116 generally flows more easily through the heat transfer member 170 than the bobbin 118.

The heat transfer plate 170 is carried by the bobbin 118 and is formed as a unitary component with the heat transfer plate 170, the bobbin being over-molded on the heat transfer plate. In order to produce the arrangement shown in FIG. 18, the heat transfer plate 170 is first formed, such as by a stamping or molding process. The heat transfer plate is then arranged in a predetermined position in a bobbin mold. When the bobbin resin is inserted into the bobbin mold, the resin flows around the heat transfer plate 170, surrounding portions of the heat transfer plate. When the resin hardens, the heat transfer plate is 170 is fixed in place on the bobbin, and the bobbin and heat transfer plate are formed as a unitary component. Small surface features formed in the heat transfer plate 170, such as holes or dimples 178, further lock the heat transfer plate 170 in place relative to the bobbin 118, as hardened resin within these surface features prevents movement of the heat transfer plate relative to the bobbin 118.

With reference to FIG. 19, a cross-sectional view of a bobbin 118 is shown including an outer diameter wall 180, and inner diameter wall 182, and a slot extension 184. The bobbin 118 is formed as a unitary component with a heat transfer plate 170. In this embodiment, the bobbin 118 and the heat transfer plate 170 are co-molded from the same material such that the material forming the parts is continuous and uninterrupted between the parts. Accordingly, when viewing a cross-section of the part, no lines of material distinction are visible between the parts that from the unitary component. In the arrangement of FIG. 19, both the bobbin 118 and the heat transfer plate 170 are be made of the same thermally conductive but electrically insulating material, such as a highly thermally conductive polyamide or polypropylene. In order to produce the arrangement shown in FIG. 19, a single mold is provided that is configured to simultaneously produce both the bobbin 118 and the heat transfer plate 170 as a unitary component. Resin is inserted into the mold and flows through the mold channels to form both the bobbin 118 and the heat transfer plate 170. When the resin hardens, the heat transfer plate is 170 is fixed in place on the bobbin, and the bobbin and heat transfer plate are formed as a unitary component. In this embodiment, the bobbin 118 itself acts as part of the heat transfer plate 170, such that heat transferred though the bobbin 118 flows directly into the tube portions 172 without a material gradient. The cooling tubes retained by the heat transfer plate carry heat away from the unitary bobbin 118 and heat transfer plate.

With reference again to FIG. 4, operation of the electric machine 110 occurs when the stator windings 116 are energized. Energization of the windings 116 may occur in various ways, such as by connecting the windings to a DC power source (not shown), such as an automotive battery, causing electric current to flow through the windings 116. Energization of the windings creates an electro-motive force on the rotor 122, resulting in rotation of the rotor. As current flows through the windings 116 during operation of the electric machine, heat is generated in the windings 116. The cooling tube 150 is in contact with the windings 116 either directly or indirectly by a heat transfer enhancer (such as heat transfer plate 170). Accordingly, heat generated in the windings 116 is transferred to the cooling tube 150. This heat is then transferred to fluid flowing through the cooling tube 150, which carries the heat to a location remote from the electric machine. In this manner, the electric machine 110 is cooled by the arrangement disclosed herein, including cooling tubes in direct or indirect contact with the stator windings.

With reference now to FIG. 20, a block diagram illustrates different steps in a method 200 for completing the winding on the bobbin and the stator core. The steps taken by the manufacturer depends on the desired arrangement of the heat transfer enhancer in relation to the bobbin and windings. As noted in block 202, a stator core is provided prior to any windings being formed on the stator core. In decision block 204, it is determined whether the heat transfer enhancer (“HTE” in FIG. 20) will extend between different winding layers (i.e., be sandwiched between conductors). If the heat transfer enhancer will extend between the winding layers, the heat transfer enhancer and the bobbin are prepared separately, as noted in block 210, the bobbin including passages configured to receive the heat transfer enhancer. The bobbin is then positioned on the stator core. Next, as noted in block 212, partial windings are formed on the stator core. When the partial windings are completed to a layer that will engage the heat transfer enhancer, the winding process is suspended and the heat transfer enhancer is inserted through the bobbin and into engagement with the winding, as noted in block 240. Then, as noted at block 242, the winding process is completed with the heat transfer enhancer extending into the completed winding. Thereafter, the cooling tubes are attached to the heat transfer enhancer as noted at block 260. Attachment of the cooling tubes to the heat transfer enhancer in block 260 may be accomplished using any of various means, including adhesives, brazing, potting, friction fit, crimping, or mechanical fasteners, as discussed previously. Once the cooling tubes are attached to the stator, the stator is completed and configured for enhanced cooling capability during operation of the electric machine.

Returning to block 204, if the heat transfer enhancer will not extend into the windings (i.e., between winding layers), different steps are followed in order to complete the winding. In particular, at decision block 230, it is determined whether the heat transfer enhancer will be integrally formed with the bobbin. If the bobbin and heat transfer enhancer will not be integrally formed, the bobbin and the heat transfer enhancer are prepared separately as noted in block 232, and the bobbin is positioned on the stator core. At block 234 a determination is made whether the heat transfer enhancer will be positioned above the windings (e.g., as shown in FIG. 16) or below the winding layers (e.g., as shown in FIG. 15). If the heat transfer enhancer will be positioned below the winding layers, the heat transfer enhancer is positioned on the bobbin, as noted in block 240. Then, as noted in block 242, the complete windings are formed on the bobbin and stator core. Thereafter, the cooling tubes are attached to the heat transfer enhancer as noted at block 260.

Returning to decision block 234, if the heat transfer enhancer will be positioned above the winding layers, the windings are first completed on the bobbin and stator core, as noted in block 236. Then, as noted in block 238, the heat transfer enhancer is positioned on the bobbin, extending over the outer layer of the windings. Following this, the cooling tubes are attached to the heat transfer enhancer as noted at block 260.

Returning again to decision block 230, if the heat transfer enhancer and the bobbin are not formed separately, they are integrally formed, as noted at block 250. Then, as noted in block 252, the windings are wound on the bobbin. Thereafter, the cooling tubes are attached to the heat transfer enhancer as noted at block 260.

The foregoing detailed description of one or more exemplary embodiments of the heat transfer enhancer for an electric machine has been presented herein by way of example only and not limitation. It will be recognized that there are advantages to certain individual features and functions described herein that may be obtained without incorporating other features and functions described herein. For example, while different exemplary configurations of the heat transfer member have been shown above, including different shapes, positions, and numbers of heat transfer members, it will be recognized that numerous additional configurations are possible. Moreover, it will be recognized that various alternatives, modifications, variations, or improvements of the above-disclosed exemplary embodiments and other features and functions, or alternatives thereof, may be desirably combined into many other different embodiments, systems or applications. Presently unforeseen or unanticipated alternatives, modifications, variations, or improvements therein may be subsequently made by those skilled in the art which are also intended to be encompassed by the appended claims. Therefore, the spirit and scope of any appended claims should not be limited to the description of the exemplary embodiments contained herein.

What is claimed is:

1. An electric machine comprising:
a core defining a first axial end, a second axial end opposite the first axial end, and a plurality of slots extending between the first axial end and the second axial end;
windings wound on the core, the windings including in-slot portions positioned in the plurality of slots and end turn portions positioned on the first axial end and the second axial end;
a cooling tube coupled to the end turn portions of the windings; and
a heat transfer member extends between the cooling tube and the windings and is in contact with the cooling tube and the windings.

2. The electric machine of claim 1 wherein the heat transfer member is connected to the cooling tube using a brazed connection, a crimped connection, an adhered connection, a potted connection or a clipped connection.

3. The electric machine of claim 2 wherein the heat transfer member includes a first portion that extends at least partially around the cooling tube and a second portion that contacts a plurality of conductors of one of the end turn portions.

4. The electric machine of claim 3 wherein the first portion of the heat transfer member is a cupped portion that extends partially around the cooling tube.

5. The electric machine of claim 4 wherein the cupped portion extends about 180° around the cooling tube.

6. The electric machine of claim 3 wherein the second portion of the heat transfer member is a plate portion that contacts the conductors.

7. The electric machine of claim 6 wherein the conductors are arranged in layers and the plate portion is sandwiched between a first layer and a second layer of the plurality of conductors.

8. The electric machine of claim 7 wherein the plate portion includes a first plate portion extending from a first axial side of the cooling tube and a second plate portion extending from the second axial side of the cooling tube, the first plate portion sandwiched between the first layer and the second layer of the plurality of conductors, and the second plate portion sandwiched between the third layer and the fourth layer of the plurality of conductors.

9. The electric machine of claim 6 wherein the plate portion includes two opposing sides and only one of the two opposing sides is in contact with the conductors.

10. The electric machine of claim 9 wherein the plate portion is in contact with an axially outermost layer of the conductors.

11. The electric machine of claim 9 wherein the plate portion is in contact with an axially innermost layer of the conductors.

12. The electric machine of claim 6 wherein the plate portion is flat.

13. The electric machine of claim 1 further comprising a bobbin coupled to the core with the windings wound on the bobbin, the bobbin including a wall extending in an axial direction from the first axial end or the second axial end of the core, and the cooling tube in contact with the wall.

14. The electric machine of claim 13 wherein the heat transfer member extends through the wall.

15. The electric machine of claim 13 wherein the heat transfer member is integral with the wall.

16. An electric machine comprising:
a core;
windings positioned on the core;
a cooling tube coupled to the windings; and
a heat transfer plate extending from the windings to the cooling tube.

17. The electric machine of claim 16 wherein the heat transfer plate includes a first portion that extends at least partially around the cooling tube and a second portion that contacts a plurality of conductors of the windings.

18. The electric machine of claim 17 wherein the heat transfer plate is sandwiched between the plurality of conductors.

19. The electric machine of claim 18 wherein the core is a stator core and the plurality of conductors are provided on an end turn portion of the windings.

20. A method of operating an electric machine comprising:
energizing windings wound on a core;
directing fluid through a cooling tube in contact with the windings; and
transferring heat generated in the windings to the cooling tube through a heat transfer plate extending from the windings to the cooling tube.
